(19) United States
(12) Patent Application Publication
(10) Pub. No.: US 2010/0044227 A1
(43) Pub. Date: Feb. 25, 2010

(54) SEPARATION OF A MIXTURE

(76) Inventors: Yong Hyup KIM, Seoul (KR); Taewoo Kim, Changwon-si (KR)

Correspondence Address: Yong Hyup, Acrovista C-505, 1685-3 Seocho-dong, Seocho-gu, Seoul, 137-921, KR

(21) Appl. No.: 12/197,852

(22) Filed: Aug. 25, 2008

(51) Int. Cl. B01D 57/02

(52) U.S. Cl. 204/450; 204/601

(57) ABSTRACT

Apparatus and techniques for separating a mixture including at least two substances having different dielectric constants are provided. A separation apparatus may include one or more separation channels associated with at least one set of two electrodes and one or more recycle channels configured to form one or more recycle loops in communication with the one or more separation channels.

### TECHNICAL FIELD

The present disclosure generally relates to the field of dielectrophoresis.

### BACKGROUND

Separation processes can be defined as processes that utilize differences in physical, chemical, or electrical properties to isolate selected substances from a mixture or from each other. Separation technologies have the potential to reduce waste, improve energy efficiency, increase the efficiency of raw material use, or enhance productivity, among others, by separating valuable materials.

Carbon nanotubes (CNTs) have mechanical, thermal, and electrical properties that make them useful in various applications, such as nanotechnology, electronics, and optics. CNTs include single-walled nanotubes (SWNTs) and multi-walled nanotubes (MWNTs). SWNTs can be classified into two types, metallic SWNTs (M-SWNTs) and semiconducting SWNTs (S-SWNTs), based on their electronic properties. M-SWNTs have high electrical conductivity, while S-SWNTs have the typical electrical and thermal properties of semiconductors. As a result, M-SWNTs are used in transparent conductive electrodes, nanoscale electrical circuits, field emitters, and RF switches, among others, while S-SWNTs are used as nanoscale field effect transistors or sensors, for example.

### SUMMARY

Embodiments of separation apparatus, separating systems, and separating methods are disclosed herein. In accordance with one embodiment by way of non-limiting example, a separation apparatus includes one or more separation channels associated with at least one set of two electrodes, where the electrodes are configured to generate a non-uniform electric field selected to at least partially separate substances having different dielectric constants, and one or more recycle channels configured to form one or more recycle loops in communication with the one or more separation channels.

In another embodiment, a separation system includes a separation apparatus described above, and one or more of a sample chamber positioned to provide a sample including at least two substances having different dielectric constants to the separation apparatus, one or more collection chambers positioned to collect one or more portions enriched in one or more separated substance from the separation apparatus, and an analyzer unit positioned to analyze portions of the sample from the separation apparatus.

In another embodiment, a separation method includes subjecting a sample containing at least two substances having different dielectric constants to a non-uniform electric field under conditions effective for at least partial separation of the sample into at least one first portion enriched in one substance and a second portion containing a remainder of the sample and recycling the second portion for iterative separation.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIGS. 1A-B show illustrative embodiments of a uniform electric field (FIG. 1A) and a non-uniform electric field (FIG. 1B).

FIG. 2 shows an illustrative embodiment of a separation apparatus.

FIGS. 3A-B show another illustrative embodiment of a separation apparatus.

FIG. 4 shows another illustrative embodiment of a separation apparatus.

FIGS. 5A-B show an illustrative embodiment of a separation apparatus having a plurality of separation channels and recycle loops.

FIG. 6A-B show another illustrative embodiment of a separation apparatus having a plurality of separation channels and recycle loops.

FIG. 7 shows an illustrative embodiment of a set of two electrodes.

FIG. 8 shows an illustrative embodiment of a separation apparatus having a plurality of separation channels.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the components of the present disclosure may be arranged and designed in a wide variety of different configurations. Those of ordinary skill will appreciate that the functions performed in the methods may be implemented in differing order, and that the outlined steps are provided only as examples, and some of the steps may be optional, combined into fewer steps, or expanded to include additional steps without detracting from the essence of the present disclosure.

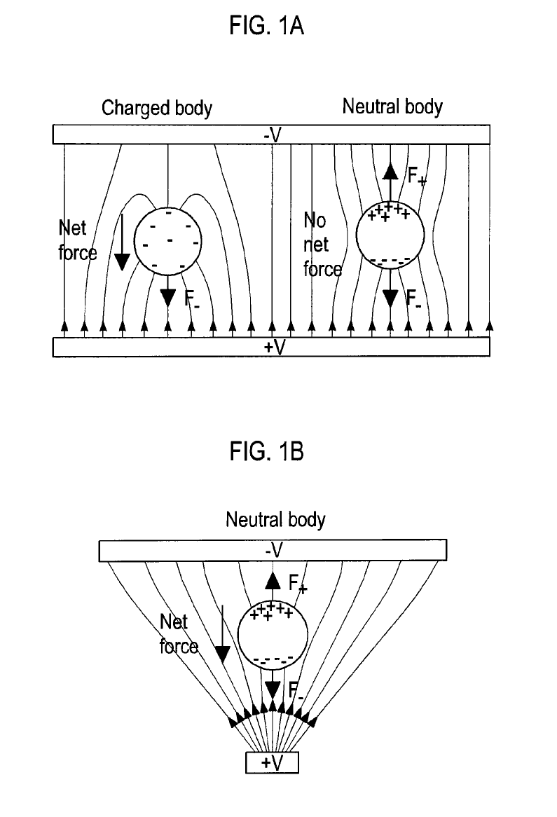

Referring to FIGS. 1A-B, illustrative embodiments of a uniform electric field and a non-uniform electric field are shown. For example, in a uniform electric field, a dielectric particle has zero net force, because the coulombic forces acting on polarized positive and negative charges have the same magnitude and act in opposite direction, as shown in FIG. 1A. On the other hand, in a non-uniform electric field, the net force on a dielectric particle is nonzero, as shown in FIG. 1B.

Dielectrophoresis (DEP) utilizes the force exerted on a dielectric particle when the particle is subjected to a non-uniform electric field. Since DEP force on an electric charge is larger in a strong electric field, the dielectric particle is attracted toward the stronger electric field region, which is generally formed around the smaller electrodes.

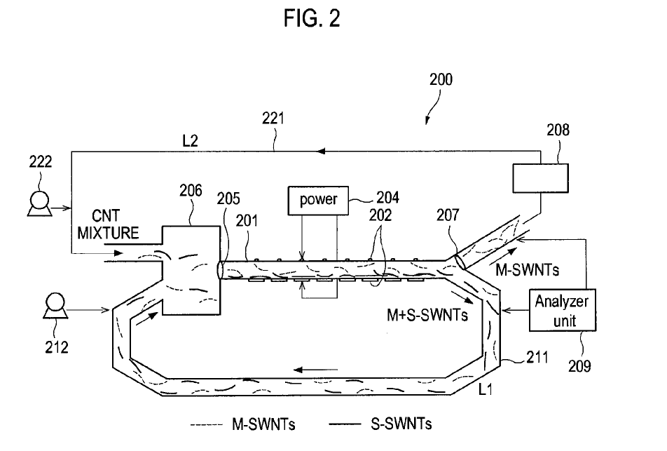

In one aspect, the present disclosure provides for separation apparatus. Referring to FIG. 2, an illustrative embodiment of a separation apparatus is shown. In certain embodiments, the separation apparatus 200 optionally includes one or more of a separation channel 201, at least one set of two electrodes 202, a power source 204, a sample input port 205, a sample chamber 206, one or more of a sample output port 207, a collection chamber 208, an analyzer unit 209, one or more recycle channels 211, 221, and at least one pump 212, 222. The separation channel 201 is associated with the at least one set of two electrodes 202, which are configured to generate a non-uniform electric field to separate substances having different dielectric constants. In some embodiments, the non-uniform electric field is configured to separate at least one substance from a sample containing at least two substances having different dielectric constants. In illustrative embodiments, the sample includes a mixture of M-SWNT and S-SWNT.

A power source 204 may be connected to the at least one set of two electrodes 202 in order to apply a voltage, e.g., an alternating current (AC) voltage or an alternating current voltage and a direct current (DC) voltage simultaneously. In illustrative embodiments, an alternating current power generator with a sinoidal waveform may be used as a power source. In operation, the peak to peak voltage may range from about 1 V to about 50 V. In some embodiments, the peak to peak voltage may range from about 3 V to about 50 V, from about 5 V to about 50 V, from about 10 V to about 50 V, from about 20 V to about 50 V, from about 30 V to about 50 V, from about 40 V to about 50 V, from about 1 V to about 3 V, from about 1 V to about 5 V, from about 1 V to about 10 V, from about 1 V to about 20 V, from about 1 V to about 30 V, from about 1 V to about 40 V, from about 3 V to about 5 V, from about 5 V to about 10 V, from about 10 V to about 20 V, from about 20 V to about 30 V, or from about 30 V to about 40 V. In other embodiments, the peak to peak voltage may be about 1 V, about 3 V, about 5 V, about 10 V, about 20 V, about 30 V, about 40 V, about 50 V. The voltage may be changed over time or for different sample concentrations/amounts and recycle routes. For example, the voltage may be adjusted to a lower level, as the amount of the sample to be separated decreases and no additional samples are newly supplied to the separation apparatus. In other embodiments, the sample flow rate may also affect the voltage to be used. For example, when the sample flow rate is relatively high, the voltage may be adjusted to a higher level.

The separation channel 201 may be formed as microchannels on a substrate. The substrate may be made of materials typically used in semiconductors including, but not limited to, silicon, glass, ceramic, and plastic. The separation channel 201 may be made of any non-conducting substance, as long as it is not dissolved by solvents. For example, when the solvent is deionized water, most polymer materials, such as but not limited to, poly(methylmethacrylate) and polycarbonate, may be used to make the separation channel 201. The separation channel 201 may be fabricated using commonly known methods for making microchannels, including but not limited to, molding and etching.

The diameter or width of the separation channel 201 may range, without limitation, from about 1 μm to about 200 μm. In some embodiments, the diameter or width of the separation channel 201 may range from about 3 μm to about 200 μm, from about 5 μm to about 200 μm, from about 10 μm to about 200 μm, from about 50 μm to about 200 μm, from about 100 μm to about 200 μm, from about 150 μm to about 200 μm, from about 1 μm to about 3 μm, from about 1 μm to about 5 μm, from about 1 μm to about 10 μm, from about 1 μm to about 50 μm, from about 1 μm to about 100 μm, from about 1 μm to about 150 μm, from about 3 μm to about 5 μm, from about 5 μm to about 10 μm, from about 10 μm to about 50 μm, from about 50 μm to about 100 μm, or from about 100 μm to about 150 μm, In other embodiments, the diameter or width of the separation channel 201 may be about 1 μm, about 3 μm, about 5 μm, about 10 μm, about 50 μm, about 100 μm, about 150 μm, or about 200 μm. The diameter or width of the separation channel 201 may be even larger than 200 μm, if it is possible to apply a high voltage to the channel.

The length of the separation channel 201 may range, without limitation, from about 100 μm to about 100 cm. In some embodiments, the length of the separation channel 201 may range from about 1 mm to about 100 cm, from about 1 cm to about 100 cm, from about 5 cm to about 100 cm, from about 20 cm to about 100 cm, from about 50 cm to about 100 cm, from about 100 μm to about 1 mm, from about 100 μm to about 1 cm, from about 100 μm to about 5 cm, from about 100 μm to about 20 cm, from about 100 μm to about 50 cm, from about 1 mm to about 1 cm, from about 1 cm to about 5 cm, from about 5 cm to about 20 cm, or from about 20 cm to about 50 cm, In other embodiments, the length of the separation channel 201 may be about 100 μm, about 1 mm, about 1 cm, about 5 cm, about 20 cm, about 50 cm, or about 100 cm.

The magnitude of the electric field may depend on the ratio of the voltage and the diameter of the separation channel. In illustrative embodiments, the electric field may range from about 10⁴ V/m to about 10⁷ V/m. In some embodiments, the electric field may range from about 10⁵ V/m to about 10⁷ V/m, from about 10⁶ V/m to about 10⁷ V/m, from about 10⁴ V/m to about 10⁵ V/m, from about 10⁴ V/m to about 10⁶ V/m, In other embodiments, the electric field may be about 10⁴ V/m, about 10⁵ V/m, about 10⁶ V/m, or about 10⁷ V/m.

The separation apparatus 200 may include the sample input port 205 in the separation channel 201 through which a sample to be separated can be introduced into the separation channel 201. The sample input port 205 may be made of any non-conducting substance as long as it is not dissolved by solvents. For example, when the solvent is deionized water, most polymers may be used to make the sample input port 205. The diameter or width of the sample input port 205 may be the same as or larger than that of the separation channel 201. In some embodiments, the sample input port 205 may have one or more valves (not shown) which may be operated to release the sample into the separation channel 201 and control the sample flow. In some embodiments, the one or more valves may be automated and controlled by an electronic device. For example, the separation apparatus 200 may include, by way of non-limiting example, a controller (not shown), such as a computer. The controller may operate by a computer program stored on the hard disk drive or through other computer programs, such as programs stored on a removable disk. In other embodiments, the controller may be a programmable logic computer (PLC), such as an Allen-Bradley Controllogix Processor or a Modicon PLC.

The sample flow rate may range, by way of non-limiting example, from about 0.05 ms⁻¹ to about 10 ms⁻¹. In some embodiments, the sample flow rate may range from about 0.1 ms⁻¹ to about 10 ms⁻¹, from about 0.6 ms⁻¹ to about 10 ms⁻¹, from about 2.5 ms⁻¹ to about 10 ms⁻¹, from about 5 ms⁻¹ to about 10 ms⁻¹, from about 7.5 ms⁻¹ to about 10 ms⁻¹, from about 0.05 ms⁻¹ to about 0.1 ms⁻¹, from about 0.05 ms⁻¹ to about 0.6 ms⁻¹, from about 0.05 ms⁻¹ to about 2.5 ms⁻¹, from about 0.05 ms⁻¹ to about 5 ms⁻¹, from about 0.05 ms⁻¹ to about 7.5 ms⁻¹, from about 0.1 ms⁻¹ to about 0.6 ms⁻¹, from about 0.6 ms⁻¹ to about 2.5 ms⁻¹, from about 2.5 ms⁻¹ to about 5 ms⁻¹, or from about 5 ms⁻¹ to about 7.5 ms⁻¹. In other embodiments, the sample flow rate may be about 0.05 ms⁻¹, about 0.1 ms⁻¹, about 0.6 ms⁻¹, about 2.5 ms⁻¹, about 5 ms⁻¹, about 7.5 ms⁻¹, or about 10 ms⁻¹.

Further, a portion of the separation channel 201 including the sample input port 205 may define the sample chamber 206 capable of holding the sample to be separated. The sample chamber 206 may be made of any non-conducting substance as long as it is not dissolved by solvents. For example, when the solvent is deionized water, most polymers may be used to make the sample chamber 206. Further, the sample chamber 206 may have any size/volume or shape, as long as it can adequately hold the sample to be separated.

The separation apparatus 200 may further include the one or more of a sample output port 207 in the separation channel 201 configured to remove portions of the sample from the separation channel 201. The sample output port 207 may be made of any non-conducting substance as long as it is not dissolved by solvents. For example, when the solvent is deionized water, most polymers may be used to make the sample output port 207. The diameter or width of the sample output port 207 may be the same as or smaller than that of the separation channel 201. In some embodiments, the sample output port 207 may have one or more valves (not shown) which may be operated to allow the sample to be removed from the separation channel 201 and released into the collection chamber 208 and control the sample flow. In some embodiments, the one or more valves may be automated and controlled by an electronic device, such as a controller or computer (not shown).

In some embodiments, the collection chamber 208 may be positioned to collect the portions enriched in one or more separated substance from the separation apparatus 200. For example, the collection chamber 208 may be coupled to the sample output port 207, to receive and hold a portion of the separated substance from the sample. The collection chamber 208 may be made of any non-conducting substance as long as it is not dissolved by solvents. Further, the collection chamber 208 may have any size/volume or shape, as long as it can adequately hold the separated substance from the sample.

In certain embodiments, the apparatus 200 may further include a device (not shown) coupled to the sample chamber 206 for dispersing the sample to be separated. The device may be capable of generating ultrasonic waves or microwaves, or the like. In some embodiments, the sample may be sonicated using a high power ultrasonic tip (120 W, 60 kHz). In other embodiments, a microwave treatment at high temperature (e.g., 500° C.) may be carried out to remove impurities and facilitate the dispersion of the sample.

In some embodiments, the apparatus 200 may further include the analyzer unit 209 which is configured to analyze portions of the sample from the separation apparatus 200. In illustrative embodiments by way of non-limiting example, the analyzer unit 209 may be an optical absorption spectrometer or a Raman spectrometer. In some embodiments, the analyzer unit 209 may be coupled to the sample output port 207, the collection chamber 208, and/or the recycle channels 211, 221, where the ratio of the different substances in the sample and the degree of enrichment of the collected separated substances may be measured. For instance, the relative enrichment ratio of the separated substances in the sample may be determined by obtaining the integrated intensities of the respective peaks or bands from the observed spectrum (e.g., a 514-nm excited Raman spectrum) and dividing them to calculate the ratio. As a result, various process conditions, such as the voltage to be applied, sample flow rate, the number and order of recycling, etc., can be determined.

In some embodiments, the one or more recycle channels 211, 221 are configured to form one or more recycle loops in communication with the one or more separation channels 201. In some embodiments, the one or more recycle channels 211, 221 may be formed as microchannels on a substrate, similar to the separation channel 201. The recycle channels 211, 221 may be made of similar materials used to make the separation channel 201, using commonly known methods for making microchannels, including but not limited to, molding and etching.

The diameter or width of the recycle channels 211, 221 may range, without limitation, from about 1 μm to about 200 μm. In some embodiments, the diameter or width of the recycle channels 211, 221 may range from about 3 μm to about 200 μm, from about 5 μm to about 200 μm, from about 10 μm to about 200 μm, from about 50 μm to about 200 μm, from about 100 μm to about 200 μm, from about 150 μm to about 200 μm, from about 1 μm to about 3 μm, from about 1 μm to about 5 μm, from about 1 μm to about 10 μm, from about 1 μm to about 50 μm, from about 1 μm to about 100 μm, from about 1 μm to about 150 μm, from about 3 μm to about 5 μm, from about 5 μm to about 10 μm, from about 10 μm to about 50 μm, from about 50 μm to about 100 μm, or from about 100 μm to about 150 μm, In other embodiments, the diameter or width of the recycle channels 211, 221 may be about 1 μm, about 3 μm, about 5 μm, about 10 μm, about 50 μm, about 100 μm, about 150 μm, or about 200 μm. In some embodiments, the diameter or width of the recycle channels 211, 221 may be even larger than 200 μm, depending on the size of the separation channel 201.

The length of the one or more recycle channels 211, 221 may range, without limitation, from about 150 μm to about 800 cm. In some embodiments, the length of the recycle channels 211, 221 may range from about 1.5 mm to about 800 cm, from about 15 mm to about 800 cm, from about 1.5 cm to about 800 cm, from about 15 cm to about 800 cm, from about 160 cm to about 800 cm, from about 400 cm to about 800 cm, from about 150 μm to about 1.5 mm, from about 150 μm to about 15 mm, from about 150 μm to about 1.5 cm, from about 150 μm to about 15 cm, from about 150 μm to about 160 cm, from about 150 μm to about 400 cm, from about 1.5 mm to about 15 mm, from about 15 mm to about 1.5 cm, from about 1.5 cm to about 15 cm, from about 15 cm to about 160 cm, from about 160 cm to about 400 cm. In other embodiments, the length of the recycle channels 211, 221 may be about 150 μm, about 1.5 mm, about 15 mm, about 1.5 cm, about 15 cm, about 160 cm, about 400 cm, or about 800 cm.

In some embodiments, the recycle channels 211, 221 may have one or more valves which would allow an additional collection chamber (not shown) to be positioned for receiving the portion containing the unseparated portion of the sample that remains after separation. In some embodiments, the one or more valves may be automated and controlled by an electronic device, such as a computer. In other embodiments, the recycle channels 211, 221 may be coupled to the analyzer unit 209 to measure the ratio of the different substances in the sample, whereby separation conditions, such as voltage, sample flow rate, and the number and order of recycling, can be controlled based on the observed data from the analyzer.

In operation, the one or more recycle loops in the separation apparatus include a first recycle loop L1 configured to recycle an unseparated portion of the sample, back to a portion of the separation channel 201 upstream of the electrodes 202. In other embodiments, the one or more recycle loops may include one or more second recycle loops L2 configured to recycle one or more portions enriched in one substance separated from the sample, back to a portion of the separation channel 201 upstream of the electrodes 202.

Referring to FIG. 2, the separation channel 201 may be connected to the recycle channel 211 to constitute a continuous, recycle loop L1 for continuously recycling an unseparated portion of the sample that remains after separation. The recycle channel 211 may include the pump 212 which drives the portion containing the unseparated portion of the sample that remains after separation to circulate through recycle loop L1. By way of non-limiting example, a syringe pump may be used as the pump 212, but any other pump known to be effective for recycling fluid may be coupled to the recycle channel 211. In illustrative embodiments, the pump 212 may provide a sample flow rate within the recycle channel 211 ranging from about 0.05 ms⁻¹ to about 10 ms⁻¹. In some embodiments, the pump 212 may provide sample flow rates ranging from about 0.1 ms⁻¹ to about 10 ms⁻¹, from about 0.6 ms⁻¹ to about 10 ms⁻¹, from about 2.5 ms⁻¹ to about 10 ms⁻¹, from about 5 ms⁻¹ to about 10 ms⁻¹, from about 7.5 ms⁻¹ to about 10 ms⁻¹, from about 0.05 ms⁻¹ to about 0.1 ms⁻¹, from about 0.05 ms⁻¹ to about 0.6 ms⁻¹, from about 0.05 ms⁻¹ to about 2.5 ms⁻¹, from about 0.05 ms⁻¹ to about 5 ms⁻¹, from about 0.05 ms⁻¹ to about 7.5 ms⁻¹, from about 0.1 ms⁻¹ to about 0.6 ms⁻¹, from about 0.6 ms⁻¹ to about 2.5 ms⁻¹, from about 2.5 ms⁻¹ to about 5 ms⁻¹, or from about 5 ms⁻¹ to about 7.5 ms⁻¹. In other embodiments, the sample flow rates may be about 0.05 ms⁻¹, about 0.1 ms⁻¹, about 0.6 ms⁻¹, about 2.5 ms⁻¹, about 5 ms⁻¹, about 7.5 ms⁻¹, or about 10 ms⁻¹.

In some embodiments, the collection chamber 208 may define an additional second recycle channel 221 connected to the beginning part of the separation channel 201, forming another recycle loop L2 for further separating the already collected substance.

In some embodiments, recycle loop L1 may circulate portions of the sample, while operation of the other recycle loop L2 is suspended. The suspended recycle loop may have one or more valves and collection chambers to receive and hold a portion from the sample while the other recycle loop is being operated.

Although not wishing to be limited by the following description, the above separation apparatus 200 may be used to separate a CNT mixture containing M-SWNTs and S-SWNTs, as illustrated in FIG. 2. In illustrative embodiments, the CNT mixture may be prepared by dispersing purified CNTs in a solvent. Any solvent having a dielectric constant ranging from about 5 to about 1000 and capable of dispersing CNTs may be used. In some embodiments, the dielectric constant of the solvent may range from about 10 to about 1000, from about 25 to about 1000, from about 50 to about 1000, from about 100 to about 1000, from about 250 to about 1000, from about 500 to about 1000, from about 5 to about 10, from about 5 to about 25, from about 5 to about 50, from about 5 to about 100, from about 5 to about 250, from about 5 to about 500, from about 10 to about 25, from about 25 to about 50, from about 50 to about 100, from about 100 to about 250, from about 250 to about 500. In other embodiments, the dielectric constant of the solvent may be about 5, about 10, about 25, about 50, about 100, about 250, about 500, or about 1000. Suitable solvents include, without limitation, deionized water (dielectric constant: 78) or organic solvents, such as 1,2-dichlorobenzene(dielectric constant: 9.8), dimethyl formamide (DMF, dielectric constant: 37), dimethyl sulfoxide (dielectric constant: 46.7), acetonitrile (dielectric constant: 37.5), methanol (dielectric constant: 32.6), and the like.

Since the CNTs produced by the currently available methods may contain impurities, they may need to be purified before being dispersed into the solution. Alternatively, purified CNTs can be purchased directly. A suitable purification method may comprise refluxing CNTs in nitric acid (about 2.5 M) and re-suspending the CNTs in water with a surfactant (e.g., sodium cholate, sodium dodecyl sulfate) at pH 10, and then filtering the CNTs using a cross-flow filtration system. The resulting purified CNT suspension may then be passed through a filter, such as a polytetrafluoroethylene filter.

The purified CNTs may be in a powder form that can be dispersed into the solvent. In certain embodiments, an ultrasonic wave or microwave treatment can be carried out to facilitate the dispersion of the purified CNTs throughout the solvent. The dispersing may be carried out in the presence of a surfactant. Various types of surfactants including, but not limited to, sodium dodecyl sulfate, sodium dodecylbenzenesulfonate, sodium dodecylsulfonate, sodium n-lauroylsarcosinate, sodium alkyl allyl sulfosuccinate, polystyrene sulfonate, dodecyltrimethylammonium bromide, cetyltrimethylammonium bromide, Brij, Tween, Triton X, and poly(vinylpyrrolidone), may be used. In illustrative embodiments, a well-dispersed and stable CNT mixture is prepared.

The CNT mixture may be supplied through the sample input port 205 and move through the separation channel 201, thereby being subjected to the non-uniform electric field generated by the electrodes 202.

In operation, the electric field formed around the smaller electrode of the set of two electrodes 202 is stronger than that formed around the larger one. SWNTs develop an induced dipole moment when subjected to the non-uniform electric field generated by the set of two electrodes 202 in the separation channel 201. Accordingly, the interaction of the induced dipole moment with the inhomogeneous external field leads to a movement of the M-SWNTs towards the strong electric field region, whereas the S-SWNTs move in the opposite direction towards the weak electric field region. Specifically, M-SWNTs and S-SWNTs have dielectric constants larger than 1000 and smaller than 5, respectively. If the dielectric constant of the solvent is between 5 and 1000, e.g., deionized water (dielectric constant: 78) or DMF(dielectric constant: 37), the M-SWNTs are attracted to the strong electric field region (i.e., positive DEP), while the S-SWNTs move away from the strong electric field region (i.e., negative DEP) due to the relative electric forces between the CNTs and solvent. Thus, utilizing the above dielectrophoresis phenomenon, M-SWNTs and S-SWNTs can be separated while the CNT mixture is moving through the separation channel 201.

In some embodiments, the at least one set of two electrodes 202 are arranged so as to attract M-SWNTs in the direction of the sample output port 207, thereby isolating and recovering M-SWNTs from the CNT mixture into the collection chamber 208, while the remainder of the CNT mixture flows into the recycle channel 211, thereby flowing back to the beginning of the separation channel 201 via the recycle loop L1 for further, optionally continuous, iterative separation. In some embodiments, the pump 212 associated with the recycle channel 211 may facilitate the recycling of the remainder of the CNT mixture by forcing it to flow back to a portion of the separation channel 201 upstream of the electrodes 202. Any concentration of the CNT mixture may be used, as long as it is a concentration that allows the CNTs to be well dispersed and remain stable in solution. By way of non-limiting example, when the solvent is DMF, the CNT solution is typically stable at a concentration of up to 100 mg/L, whereas the CNT solution is stable at a concentration of up to 1000 mg/L when the solvent is deionized water. The above illustrated operation may be carried out under ambient conditions.

In some embodiments, the recycle loop L1 may be associated with the sample chamber 206 and/or the sample input port 205 that are coupled with the separation channel 201, and may be capable of combining the remainder of the CNT mixture with a newly supplied CNT mixture or solvent in order to optionally continuously carry out iterative recycling.

In some embodiments, the amounts of the two different types of SWNTs in the remainder of the CNT mixture or the degree of enrichment of the separated M-SWNTs may be measured by the analyzer unit 209, such as, but not limited to, an optical absorption spectrometer or a Raman spectrometer. For instance, the relative enrichment ratio of S-SWNTs/M-SWNTs can be determined by dividing the integrated intensities of the respective peaks or bands of the observed spectrum. When compared with a reference sample, such a ratio allows to derive the degree of enrichment or even to calculate the sample composition, if the composition of the original reference sample is assumed to have the theoretically expected value of 2/1. In illustrative embodiments, a Raman microscope (model CRM-200; Witec, Ulm, Germany) excited with an Ar ion laser (Spectra-Physics, Mountain View, Calif.) at 514.5 nm may be used as the analyzer unit 209. In some embodiments, an operator of the separation apparatus 200 may extract portions of the sample from different parts of the separation apparatus 200 and measure the degree of separation or enrichment using the analyzer unit 209. In other embodiments, the analyzer unit 209 may be coupled to different parts of the separation apparatus 200, e.g., the recycle channels 211, 221 and the collection chamber 208, where it may automatically receive portions of the sample for analyzing. The analyzer unit 209 may be controlled by an electronic device, such as a control computer, which can receive input signals from the analyzer unit 209 in real time and adjust particular parameters of the separation apparatus 200 based on the signals. The observed analytical data can be used as a yardstick for determining recycling conditions, such as the number and order of recycle loops and the number of circulations for each recycle loop. For example, when the analytical data indicate that the sample composition or the enrichment degree of the separated substance is approaching the target value, the number of recycle loops or the number of circulations for each recycle loop may be adjusted to be reduced. Thus, for example, if the analytical data show that the amount of M-SWNTs from the recycle channel 211 is reduced to a very low level, indicating that a sufficient amount of M-SWNTs have been collected into the collection chamber 208, the recycle process of the recycle loop L2 can be initiated (with the recycle loop L1 shut down) for further enrichment of the already separated substance, i.e., M-SWNTs.

In some embodiments, the recycle process may be carried out only with respect to the remainder of the CNT mixture, i.e., only with the recycle loop L1, without recycling the already isolated M-SWNTs, i.e., without the recycle loop L2.

In other embodiments, after a sufficient number of recycling with the recycle loop L1 is carried out, a recycle process with the recycle loop L2 can be used to further enrich the already isolated M-SWNTs. Thus, in some embodiments, the collection chamber 208 can be connected to the beginning of the separation channel 201 through the recycle channel 221, thereby forming the recycle loop L2, which allows the isolated M-SWNTs to flow back to the beginning of the separation channel 201 via the recycle loop L2 for further enrichment of M-SWNTs. In some embodiments, the pump 222 associated with the recycle channel 221 may facilitate the recycling of the isolated M-SWNTs by forcing them to flow back to a portion of the separation channel 201 upstream of the electrodes 202. The pump 222 may provide sample flow rates within the recycle channel 221 that are similar to the sample flow rates provided by the pump 212 already described above. After a sufficient number of recycling in the recycle loop L2 is carried out, the separated, purified M-SWNTs are recovered.

During the operation of the recycle loop L2, the other recycle loop L1 may be shut down by controlling one or more valves, since it is undesirable to mix the already isolated M-SWNTs with the remainder of the CNT mixture and lower the separation efficiency. Thus, the recycle loops L1 and L2 can be configured to alternately open and close using one or more valves. For example, when operating the recycle loop L2, one or more valves positioned at the beginning of the recycle channel 211 of the recycle loop L1 may be closed to block the sample solution from entering the recycle channel 211, while valves positioned at the beginning of the recycle channel 221 of the recycle loop L2 and the collection chamber 208 may be opened to allow the sample solution to enter the recycle channel 221 and move through the recycle loop L2. Further, the operation of the one or more valves in the recycle channels 211, 221 may be controlled by an electronic device, such as a control computer, where, for example, the analyzer unit 209 may monitor the composition of the CNT mixture or the degree of enrichment of the separated SWNTs.

With respect to the recycle loop L1, the remainder of the CNT mixture moving through the separation channel 201 may be collected in another collection chamber (not shown) connected to the recycle channel 211 by controlling one or more valves for additional recycling during the operation of the recycle loop L2. In some embodiments, the remainder of the CNT mixture moving through the separation channel 201 can be simply discharged to outside of the separation apparatus 200, where the recycling process of the recycle loop L1 is terminated by recovering the accumulated sample of SWNT.

In some embodiments, the number of circulations for recycle loops L1 and L2 may be determined according to the target enrichment degree of M-SWNTs. In illustrative embodiments, if the target enrichment degree is larger than 90%, the number of circulations for recycle loop L1 may be, by way of non-limiting example, more than 2, or more than 5, or more than 10 unless additional sample solutions to be separated are newly provided. Thus, if additional sample solutions to be separated are continuously supplied to the separation apparatus 200, the number of circulations for recycle loop L1 may increase infinitely. In some embodiments, the number of circulations for recycle loop L2 may be lesser than that for recycle loop L1, because the separated M-SWNTs are already relatively enriched.

In some embodiments, the separation apparatus 200 may comprise a controller (not shown), such as a control computer, optionally coupled to the power source 204, the analyzer unit 209, the at least one pump 212, 222, the one or more valves, etc. The controller may receive input signals from the different components of the separation apparatus 200 and control particular parameters of the apparatus 200, such as sample flow, voltage, the magnitude of the electric field, the number and order of recycling, etc., based on those signals. In this manner, immediate adjustments may be made with respect to the various operations relating to the separation apparatus 200.

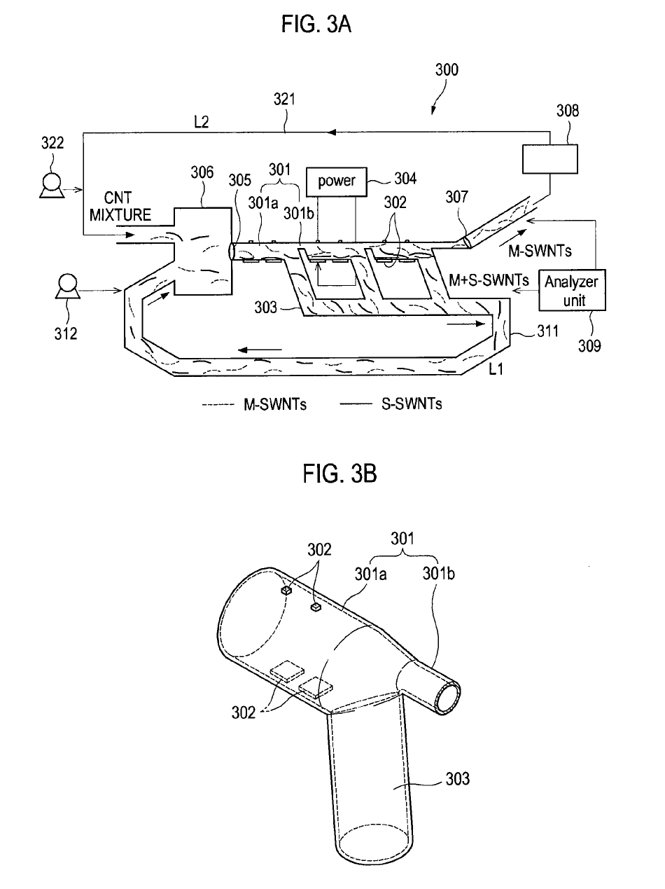

Referring to FIGS. 3A-B, an illustrative embodiment of a separation apparatus 300 is shown. In some embodiments, one or more separation channels 301 may have varying diameters along the direction of the CNT mixture flow, where the diameter of the channel alternates between larger and smaller diameters at predetermined intervals. FIG. 3B shows a perspective view of the part of the separation channel 301 having a portion with a larger diameter 301a followed by another portion with a smaller diameter 301b, where electrodes 302 are associated with the portion having a larger diameter 301a. As illustrated in FIG. 3A, the SWNTs which are selectively attracted to one side of the separation channel 301 pass through the portions 301b of the separation channel 301 having smaller diameters and become subject to the DEP force generated by the next set of electrodes 302. As a result, the above embodiment of the separation apparatus 300 where the separation channels 301 have varying diameters along the direction of the CNT mixture flow may have enhanced separation efficiency.

The diameter or width of the portions 301a of the separation channel 301 having larger diameters may be the same as the diameter or width of the separation channel 201 already described above. The diameter or width of the portions 301b of the separation channel 301 having smaller diameters may range, without limitation, from about 5% to about 100% of the diameter or width of the portions 301a having larger diameters. In some embodiments, the diameter or width of the portions 301b of the separation channel 301 having smaller diameters may range from about 20% to about 100%, from about 40% to about 100%, from about 60% to about 100%, from about 80% to about 100%, from about 90% to about 100%, from about 95% to about 100%, from about 5% to about 20%, from about 5% to about 40%, from about 5% to about 60%, from about 5% to about 80%, from about 5% to about 90%, from about 5% to about 95%, from about 20% to about 40%, from about 40% to about 60%, from about 60% to about 80%, from about 80% to about 90%, or from about 90% to about 95% of the diameter or width of the portions 301a having larger diameters. In other embodiments, the diameter or width of the portions 301b of the separation channel 301 having smaller diameters may be about 5%, about 20%, about 40%, about 60%, about 80%, about 90%, about 95%, or about 100% of the diameter or width of the portions 301a having larger diameters.

The length of the portions 301b of the separation channel 301 having smaller diameters may range, without limitation, from about 5% to about 100%, from about 10% to about 90%, or from 15% to about 70% of the length of the portions 301a having larger diameters. In some embodiments, the length of the portions 301b of the separation channel 301 may range from about 10% to about 100%, from about 15% to about 100%, from about 40% to about 100%, from about 70% to about 100%, from about 90% to about 100%, from about 95% to about 100%, from about 5% to about 10%, from about 5% to about 15%, from about 5% to about 40%, from about 5% to about 70%, from about 5% to about 90%, from about 5% to about 95%, from about 10% to about 15%, from about 15% to about 40%, from about 40% to about 70%, from about 70% to about 90%, or from about 90% to about 95% of the length of the portions 301a having larger diameters. In other embodiments, the length of the portions 301b of the separation channel 301 may be about 5%, about 10%, about 15%, about 40%, about 70%, about 90%, about 95%, or about 100% of the length of the portions 301a having larger diameters. The separation channel 301 having varying diameters may be fabricated in a predetermined pattern by using, by way of non-limiting example, a molding method or etching method.

In some embodiments, the separation apparatus 300 may further include one or more branch channels 303 that split off from each of the one or more separation channels 301 and optionally connect into the recycle channel 311, as illustrated in FIG. 3A. The branch channels 303 are configured to receive and transport portions of the CNT mixture which move away from the strong electric field formed around the smaller electrodes and do not pass through the narrower portion 301b of the separation channel 301. In some embodiments, the branch channel 303 may be configured to be at an angle of less than 90° with the advance/forward direction of the CNT mixture flow within the separation channel 301, as illustrated in FIGS. 3A-B, in order to allow the CNT mixture to flow forward while preventing it from flowing backward in the reverse direction of the CNT mixture flow. In some embodiments, the branch channels 303 may be connected to one common branch channel, as illustrated in FIG. 3A.

Descriptions regarding some of the components illustrated in FIGS. 3A-B, for example, a power source 304, a sample input port 305, a sample chamber 306, one or more of a sample output port 307, a collection chamber 308, an analyzer unit 309, a recycle channel 321, and pumps 312, 322, which are similar to the corresponding components already described and illustrated in FIG. 2, are not necessarily repeated herein.

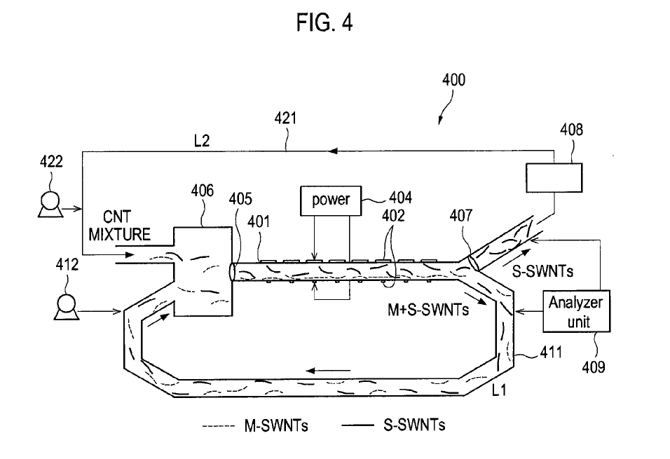

Referring to FIG. 4, another illustrative embodiment of a separation apparatus 400 is shown. In some embodiments, the at least one set of two electrodes 402 are so arranged as to attract S-SWNTs in the direction of the sample output port 407, thereby separating and recovering S-SWNTs from the CNT mixture into the collection chamber 408, while the remainder of the CNT mixture flows into the recycle channel 411 and eventually back to the beginning of the separation channel 401 via the recycle loop L1 for further continuous, iterative separation. Descriptions regarding some of the components illustrated in FIG. 4, for example, a power source 404, a sample input port 405, a sample chamber 406, an analyzer unit 409, a recycle channel 421, and pumps 412, 422, which are similar to the corresponding components already described and illustrated in FIG. 2, are not necessarily repeated herein.

With respect to the apparatus shown in FIGS. 3 and 4, the typical operational steps, i.e., subjecting the CNT mixture to the non-uniform electric field under conditions effective to separate the specific type of CNTs, and recycling the remainder of the CNT mixture or the separated specific type of SWNT back to the subjecting for iterative separation, are carried out in the same manner as that described above for the embodiment illustrated in FIG. 2, with additional requirements, such as the modification of the separation channel 301 to include the branch channels 303 and the reversed arrangement of the electrodes 402, respectively.

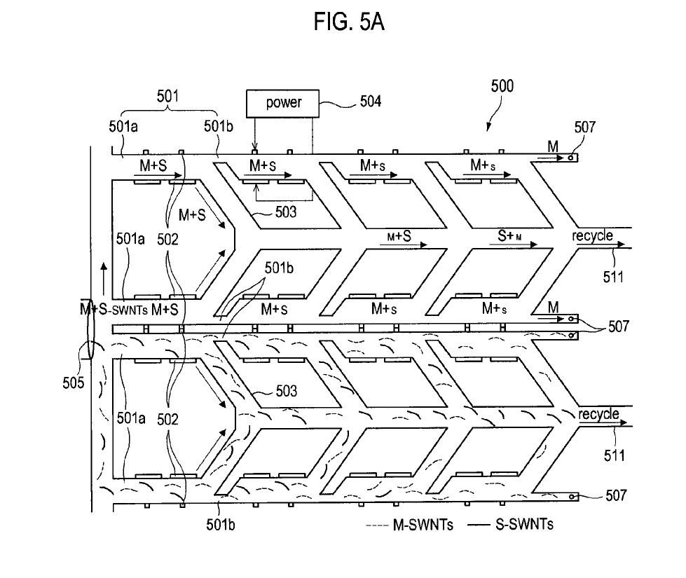

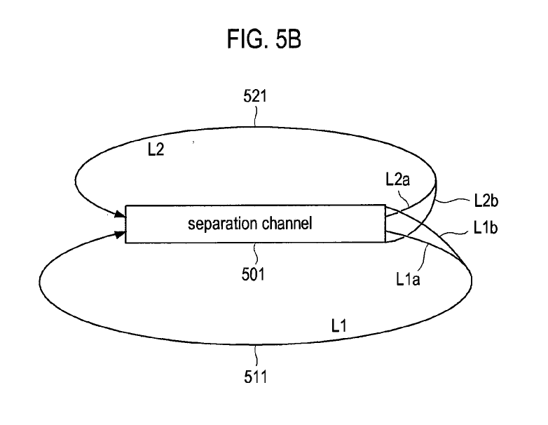

Referring to FIGS. 5A-B, an illustrative embodiment of a separation apparatus 500 having a plurality of separation channels and recycle loops is shown. In some embodiments, the separation apparatus 500 may have two or more separation channels 501 in order to process a large amount of sample at the same time. As illustrated in FIGS. 5A-B, the at least one set of two electrodes 502 may be arranged so as to attract M-SWNTs (indicated by the symbol “M” or a dotted line) in the direction of two or more sample output ports 507, thereby separating and recovering M-SWNTs from the CNT mixture into the one or more collection chambers (not shown), while the remainder of the CNT mixture flows into the one or more recycle channels 511 and back to the beginning of the two or more separation channels 501 via the one or more recycle loops L1 for further, optionally continuous, iterative separation.

The one or more recycle channels 511 of the one or more recycle loops L1 (L1a, L1b) may be connected to one or more common recycle channels for gathering the sample flow, prior to recycling the remainder of the CNT mixture back to the beginning of the separation channel 501, as illustrated in FIG. 5B. In the same manner, the one or more recycle channels 521 of the at least one recycle loop L2 (L2a, L2b) that circulate the separated M-SWNTs may be connected to one or more common recycle channels prior to recycling the separated M-SWNTs back to the beginning of the separation channel 501, as illustrated in FIG. 5B. The one or more common recycle channels may reduce the congestion around the sample input port 505 produced by the numerous individual recycle channels and facilitate the concentration of the sample.

Descriptions regarding some of the components illustrated in FIG. 5, for example, portions of separation channel 501a, 501b, one or more branch channels 503, a power source 504, a sample input port 505, and one or more of a sample output port 507, which are similar to the corresponding components already described and illustrated in FIGS. 2 and FIGS. 3A-B, are not necessarily repeated herein.

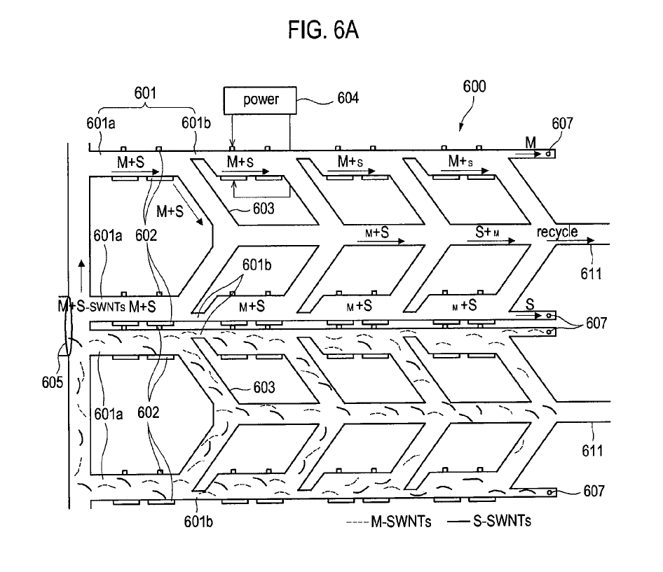

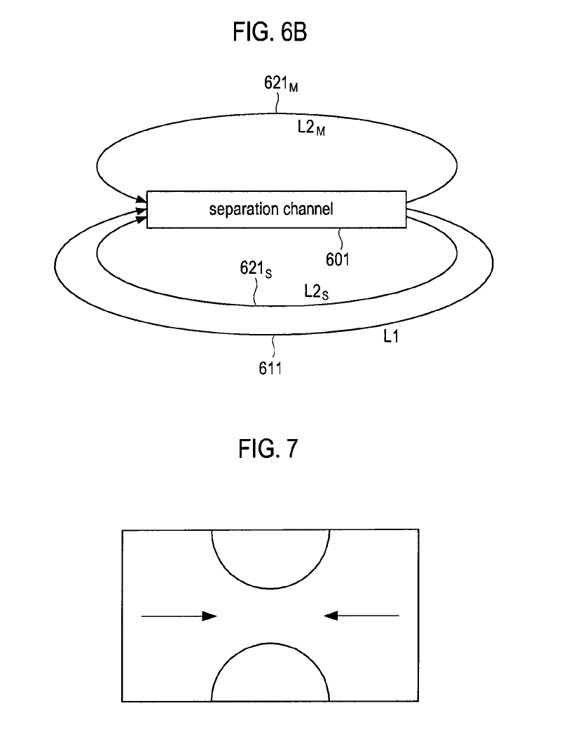

Referring to FIGS. 6A-B, an illustrative embodiment of a separation apparatus 600 having a plurality of separation channels and recycle loops is shown. As illustrated in FIGS. 6A-B, the at least one set of two electrodes 602 may be arranged so as to simultaneously attract M-SWNTs (indicated by the symbol “M” or a dotted line) or S-SWNTs (indicated by the symbol “S” or a solid line) in the direction of each output port 607 in each separation channel 601 respectively, thereby separating and recovering M-SWNTs or S-SWNT respectively from the CNT mixture into the one or more collection chambers (not shown), while the remainder of the CNT mixture flows into the one or more recycle channels 611 and back to the beginning of the two or more separation channels 601 via the one or more recycle loops L1 for further continuous, iterative separation. Thus, in operation, the separation apparatus 600 may have three different recycle loops, that is, recycle loop L1 for the remainder of the CNT mixture, recycle loop L2_{M} for the already separated M-SWNTs, and recycle loop L2_{S} for the already separated S-SWNTs, as illustrated in FIG. 6B. In some embodiments, each recycle channel 611, 621_{M}, and 621_{S} of the one or more recycle loops L1, L2_{M} and L2_{S} may be connected to one or more respective common recycle channels for gathering the sample flow, prior to subjecting each sample to the non-uniform electric field. Recycle loops L1, L2_{M} and L2_{S} may be completely separate from each other and alternately operable. For example, when one recycle loop is in operation, the other recycle loops may be shut down by controlling one or more valves while receiving and/or discharging portions of sample from the separation channels.

Descriptions regarding some of the components illustrated in FIG. 6, for example, portions of separation channel 601a, 601b, one or more branch channels 603, a power source 604, and a sample input port 605, which are similar to the corresponding components already described and illustrated in FIG. 2 and FIGS. 3A-B, are not necessarily repeated herein.

Depending on the design requirements and/or the application field, the shapes and/or arrangements of the electrodes may differ. Referring to FIG. 7, an illustrative embodiment of a set of two electrodes is shown. The intensity of the electric field is generally strong in the narrow gap between the two electrodes, and thus a relatively strong electric field is generated between the apexes of the semicircle-shaped electrodes (indicated by arrows). Therefore, in a separation apparatus including the above set of two electrodes, M-SWNTs, for instance, are attracted to the center of the gap between the two electrodes. In some embodiments, the electrodes may be formed on the inside of the channel as illustrated in FIG. 7, such that the gap between the electrodes is smaller/narrower than the diameter of the separation channel, in order to apply a stronger electric field. In other embodiments, the electrodes illustrated in FIG. 7 may be formed on the outside of the separation channel. The gap between the two opposite electrodes illustrated in FIG. 7 may range, without limitation, from about 1 μm to about 200 μm depending on the diameter of the separation channel. In some embodiments, the gap between the two electrodes may range from about 3 μm to about 200 μm, from about 5 μm to about 200 μm, from about 10 μm to about 200 μm, from about 50 μm to about 200 μm, from about 100 μm to about 200 μm, from about 150 μm to about 200 μm, from about 1 μm to about 3 μm, from about 1 μm to about 5 μm, from about 1 μm to about 10 μm, from about 1 μm to about 50 μm, from about 1 μm to about 100 μm, from about 1 μm to about 150 μm, from about 3 μm to about 5 μm, from about 5 μm to about 10 μm, from about 10 μm to about 50 μm, from about 50 μm to about 100 μm, or from about 100 μm to about 150 μm, In other embodiments, the gap between the two electrodes may be about 1 μm, about 3 μm, about 5 μm, about 10 μm, about 50 μm, about 100 μm, about 150 μm, or about 200 μm.

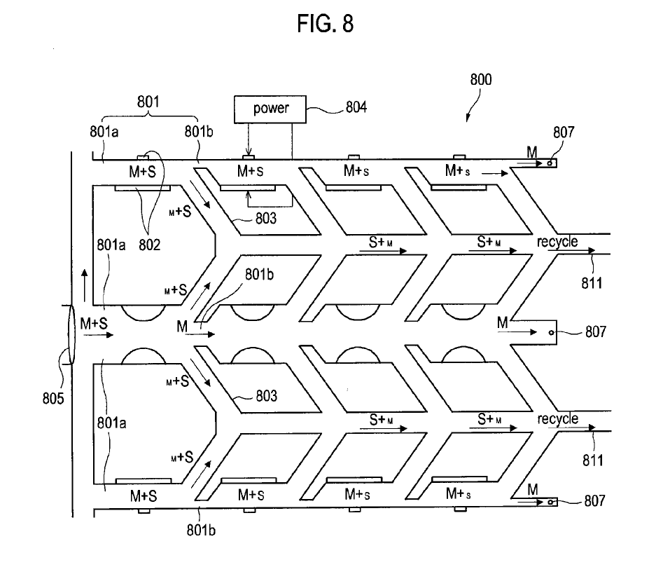

Referring to FIG. 8, another illustrative embodiment of a separation apparatus 800 having a plurality of separation channels is shown. In some embodiments, different types of sets of two electrodes 802 can be alternately arranged in each separation channel 801, as illustrated in FIG. 8. For example, the separation channels 801 may have two types of sets of two electrodes 802, which are so arranged as to attract M-SWNTs (indicated by the symbol “M”) in the direction of two or more sample output ports 807, thereby separating and recovering M-SWNTs from the CNT mixture into the one or more collection chambers (not shown), while the remainder of the CNT mixture flows into the one or more recycle channels 811 and back to the beginning of the two or more separation channels 801 via the one or more recycle loops L1 for further continuous, iterative separation. Descriptions regarding some of the components illustrated in FIG. 8, for example, portions of separation channel 801a, 801b, one or more branch channels 803, a power source 804, a sample input port 805, which arc similar to the corresponding components already described and illustrated in FIG. 2 and FIGS. 3A-B, are not necessarily repeated herein.

With respect to the apparatus shown in FIGS. 5, 6, and 8, the typical operational steps, i.e., subjecting the CNT mixture to the non-uniform electric field under conditions effective to separate the specific types of SWNTs, and recycling the remainder of the CNT mixture or the separated specific types of SWNTs back to the subjecting for iterative separation arc carried out in the same manner as that described above for the embodiment illustrated in FIGS. 2 to 4, with additional requirements, such as a modification of the separation channels to include the branch channels 503, the arrangement of the electrodes 602, and the shape of the electrodes 802, respectively.

### Equivalents

The present disclosure is not to be limited in terms of the particular embodiments described in this application. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, or compositions, which can, of course, vary. It is also to be understood that the terminology used herein is for the purpose of describing particular embodiments only, and is not intended to be limiting.

Those skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

The herein described subject matter sometimes illustrates different components contained within, or connected with, different other components. It is to be understood that such depicted architectures are merely illustrative, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A separation apparatus comprising:
one or more separation channels associated with at least one set of two electrodes, wherein the electrodes are configured to generate a non-uniform electric field selected to at least partially separate substances having different dielectric constants; and
one or more recycle channels configured to form one or more recycle loops in communication with said one or more separation channels.

2. The apparatus according to claim 1, wherein said one or more separation channels have varying diameters along the direction of sample flow, wherein the diameter of the channel alternates between larger and smaller diameters at predetermined intervals and said electrodes are associated with portions of the one or more separation channels having larger diameters.

3. The apparatus according to claim 1 further comprising one or more branch channels that split off from each of said one or more separation channels to connect into the one or more recycle channels and configured to transport portions of the sample from the one or more separation channels.

4. The apparatus according to claim 1, wherein said one or more recycle loops comprise a first recycle loop configured to recycle an unseparated portion of the sample, back to a portion of the separation channel upstream of the electrodes.

5. The apparatus according to claim 1, wherein said one or more recycle loops comprise one or more second recycle loops configured to recycle one or more portions enriched in one substance separated from the sample, back to a portion of the separation channel upstream of the electrodes.

6. The apparatus according to claim 1 further comprising one or more pumps coupled to the one or more recycle channels for recycling one or more portions enriched in one substance separated from the sample or an unseparated portion of the sample, back to a portion of the channel upstream of the electrodes.

7. The apparatus according to claim 1 further comprising a power source connected to said at least one set of two electrodes for applying a voltage.

8. The apparatus according to claim 7, wherein the power source is capable of applying an alternating current voltage.

9. The apparatus according to claim 7, wherein the power source is capable of applying an alternating current voltage and a direct current voltage simultaneously.

10. The apparatus according to claim 1 further comprising a sample input port in the one or more separation channels through which a sample to be separated can be introduced into said separation channels.

11. The apparatus according to claim 10, wherein a portion of said separation channel comprising the sample input port defines a sample chamber capable of holding the sample to be separated.

12. The apparatus according to claim 11 further comprising a device coupled to said sample chamber for dispersing the sample to be separated.

13. The apparatus according to claim 12, wherein said device is capable of generating ultrasonic waves or microwaves.

14. The apparatus according to claim 1 further comprising one or more sample output ports in the one or more separation channels configured to remove portions of the sample from said separation channels.

15. The apparatus according to claim 1, wherein said one or more separation channels are installed as microchannels on a substrate.

16. A separating system comprising: a separation apparatus including: one or more separation channels associated with at least one set of two electrodes, wherein the electrodes are configured to generate a non-uniform electric field selected to at least partially separate substances having different dielectric constants; and
one or more recycle channels configured to form one or more recycle loops in communication with said one or more separation channels;
one or more of a sample chamber positioned to provide a sample including at least two substances having different dielectric constants to the separation apparatus;
one or more collection chambers positioned to collect one or more portions enriched in one or more separated substance from the separation apparatus; and
an analyzer unit positioned to analyze portions of the sample from the separation apparatus.

17. The system according to claim 16, wherein said one or more separation channels in the separation apparatus have varying diameters along the direction of sample flow, wherein the diameter of the channel alternates between larger and smaller diameters at predetermined intervals and said electrodes are associated with portions of the one or more separation channels having larger diameters.

18. The system according to claim 16 further comprising one or more branch channels that split off from each of said one or more separation channels to connect into the one or more recycle channels and configured to transport portions of the sample from the one or more separation channels.

19. The system according to claim 16, wherein said one or more recycle loops in the separation apparatus comprise a first recycle loop configured to recycle an unseparated portion of the sample, back to a portion of the separation channel upstream of the electrodes.

20. The system according to claim 16, wherein said one or more recycle loops in the separation apparatus comprise one or more second recycle loops configured to recycle one or more portions enriched in one or more substance separated from the sample, back to a portion of the separation channel upstream of the electrodes.

21. The system according to claim 16 further comprising one or more pumps coupled to the one or more recycle channels in the separation apparatus for recycling one or more portions enriched in one or more substance separated from the sample or an unseparated portion of the sample, back to a portion of the channel upstream of the electrodes.

22. The system according to claim 16 further comprising a power source connected to said at least one set of two electrodes in the separation apparatus for applying a voltage.

23. The system according to claim 22, wherein the power source is capable of applying an alternating current voltage.

24. The system according to claim 22, wherein the power source is capable of applying an alternating current voltage and a direct current voltage simultaneously.

25. The system according to claim 16 further comprising a sample input port in the one or more separation channels through which a sample to be separated can be introduced into said separation channels.

26. The system according to claim 16 further comprising a device coupled to said sample chamber for dispersing the sample to be separated.

27. The system according to claim 26, wherein said device is capable of generating ultrasonic waves or microwaves.

28. The system according to claim 16 further comprising one or more sample output ports in the one or more separation channels configured to remove portions of the sample from said separation channels.

29. The system according to claim 16, wherein said one or more separation channels are installed as microchannels on a substrate.

30. A separation method comprising:
subjecting a sample containing at least two substances having different dielectric constants to a non-uniform electric field under conditions effective for at least partial separation of the sample into at least one first portion enriched in one substance and a second portion containing a remainder of the sample; and
recycling said second portion for iterative separation.

31. The method according to claim 30 further comprising recycling said at least one first portion enriched in one substance back to said subjecting, after said recycling is suspended, for iterative separation.

32. The method according to claim 30 further comprising analyzing portions of the sample by optical absorption spectroscopy or Raman spectroscopy.

33. The method according to claim 30 comprising recovering said at least one first portion enriched in one substance after said subjecting or said recycling.

34. The method according to claim 30 further comprising dispersing the sample to be separated, prior to said subjecting.

35. The method according to claim 34, wherein said dispersing is carried out by subjecting the sample to ultrasonic waves or microwaves.

36. The method according to claim 34, wherein said dispersing is carried out in the presence of a surfactant.

37. The method according to claim 30, wherein said sample comprises a mixture of metallic carbon nanotubes and semiconducting carbon nanotubes.

38. The method according to claim 37, wherein said mixture of metallic carbon nanotubes and semiconducting carbon nanotubes is in water or an organic solvent.

39. The method according to claim 30, wherein said subjecting is carried out by applying an alternating current voltage to the sample.

40. The method according to claim 30, wherein said subjecting is carried out by applying an alternating current voltage and a direct current voltage simultaneously to the sample.

41. A separation method comprising the use of the separation apparatus according to claim 1.
